(19) United States
(12) Patent Application Publication
(10) Pub. No.: US 2018/0229349 A1
(43) Pub. Date: Aug. 16, 2018

(54) High Torque Ratchet Wrench

(71) Applicant: Chia-Yu CHEN, Taichung City (TW)

(72) Inventor: Chia-Yu CHEN, Taichung City (TW)

(21) Appl. No.: 15/432,733

(22) Filed: Feb. 14, 2017

(51) Int. Cl. B25B 13/46; B25B 23/00

(52) U.S. Cl. CPC B25B 13/463; B25B 23/0007

(57) ABSTRACT

A high torque ratchet wrench comprises a head portion having a chamber for the installation of a driving gear, a slot for the installation of a controller which comprises a control body having a recess for storing an elastic member, and a pressing pin. A ratchet block has a plurality of ratchet teeth formed thereon, a curvature section being contacted by the pressing pin of the controller, and a pair of pressing surface sections. The chamber in the head portion comprises a pair of holding surface sections corresponding to the pressing surface sections of the ratchet block. The driving gear having a radius substantially equal to the same of the ratchet teeth of the ratchet block thereby the ratchet teeth of the ratchet block will be substantially matched with the gear teeth of the driving gear.

### BACKGROUND OF THE INVENTION

### Field of the Invention

The present invention relates to a torque wrench particularly relates to a high torque ratchet wrench.

### Brief Description of the Prior Art

Referring to FIG. 1 which shows a sectional view of a conventional ratchet wrench, the ratchet wrench has a body 1 with a ratchet 2, a teethed plate 3 and a control unit 4 constructed in the body 1. The teethed plate 3 has a curved surface 5 with a predetermined curvature. The control unit 4 comprises a pressing element 7 having a spring 6 installed and supported therein so that the pressing element 7 will be pushed to press against the curved surface 5 of the teethed plate 3.

When the conventional torque wrench will be use to tighten a screw or the like, torque will be applied through the pressing element 7 of the control unit 4 to push the teethed plate 3 to closely in contact with the teeth of the ratchet 2. As shown in FIG. 1, one end of the teethed plate 3 is simply not having a complete touch with the teeth of the ratchet 2 even leave a gap between the teeth of the teethed plate 3 and the teeth of the ratchet 2. In another end of the teethed plate 3, although the teeth of the teethed plate 3 is more closely in matching the teeth of the ratchet 2, the teethed plate 3 contacted with an inner surface of the body 1 at a point “a”. The applied torque between the teeth of the ratchet 2 and the teethed plate 3 becomes not uniform causing stress concentration problem. If a large torque has been applied on the wrench, the teethed plate 3 may sometimes even to become cracked.

### SUMMARY OF THE INVENTION

It is therefore the principle object of the present invention is to provide an improved high torque ratchet wrench which shall obviate the disadvantage of the conventional torque wrench.

Another object of the present invention is to provide an improved high torque ratchet wrench having a firm connection between the gear teeth and the ratchet teeth resulting a smooth relative movement without damaging the teeth.

Still another object of the present invention is to provide an improved high torque ratchet wrench having a ratchet block which is firmly in contact with the inner surface of the chamber containing the driving gear.

The most important feature of the present invention is to provide a holding surface section in the chamber of an improved high torque ratchet wrench. The ratchet block also being stored in the chamber and has a pressing surface section corresponding to and closely in contact with the holding surface section.

Another important feature of the present invention is the driving gear having a radius substantially equal to the same of the ratchet teeth on the ratchet block. It is therefore the ratchet teeth of the ratchet block will be substantially matched with the gear teeth of the driving gear.

In summary, a high torque ratchet wrench in accordance with the present invention comprises a head portion having a chamber for the installation of a driving gear which comprises a plurality of gear teeth, a slot formed in the head portion for the installation of a controller which further comprises a control body having a recess formed therein for storing an elastic member, and a pressing pin biased by said elastic member, and a ratchet block having a plurality of ratchet teeth formed thereon, a curvature section being contacted by the pressing pin of the controller, and a pair of pressing surface sections formed thereon. The head portion comprises a pair of holding surface sections corresponding to the pressing surface sections of the ratchet block and substantially closely in touch with each other. The driving gear has a radius substantially equal to the same of the ratchet teeth of the ratchet block thereby the ratchet teeth of the ratchet block will be substantially matched with the gear teeth of the driving gear.

### BRIEF DESCRIPTION OF THE DRAWINGS

Those and other advantages, objectives and features of the high torque ratchet wrench, in accordance with the present invention, will become more apparent from the below detailed description of the preferred embodiments with reference the accompanying drawings, wherein:

FIG. 1 is a sectional view of a conventional torque wrench;

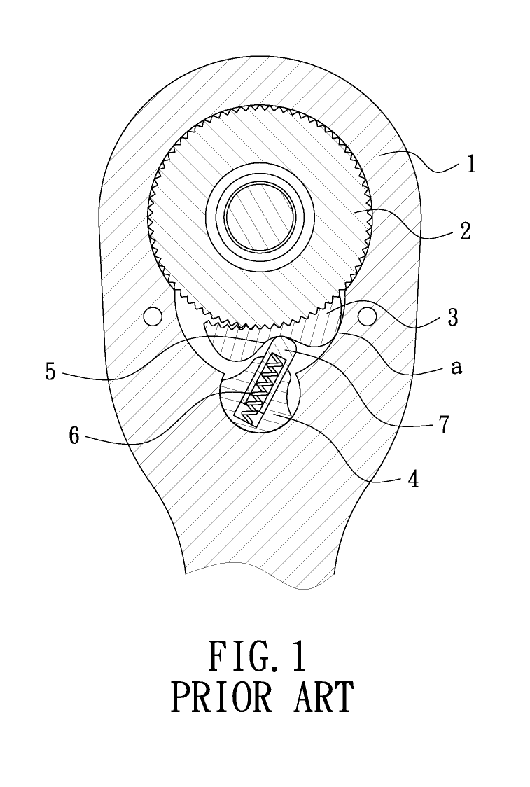

FIG. 2 is a perspective view of an embodiment of a high torque ratchet wrench in accordance with the present invention;

FIG. 3 is an exploded perspective view of an embodiment of a high torque ratchet wrench in accordance to the present invention;

FIG. 4 is a sectional view of an embodiment of a high torque ratchet wrench in accordance to the present invention;

FIG. 5 is a sectional view of an embodiment of a high torque ratchet wrench in accordance to the present invention illustrating the operation of the wrench being turned clockwise; and

FIG. 6 is a sectional view of an embodiment of a high torque ratchet wrench in accordance to the present invention illustrating the operation of the wrench being turned counter clockwise.

### DETAILED DESCRIPTION OF THE PREFERRED EMBODIMENT

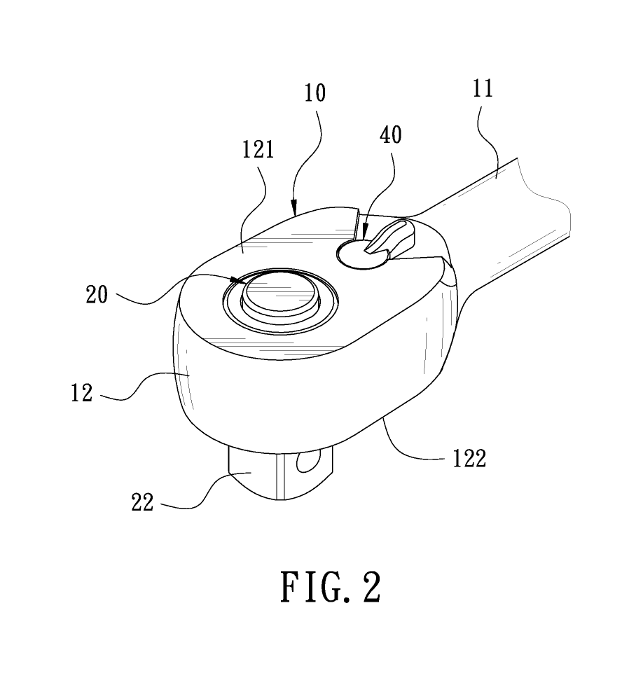

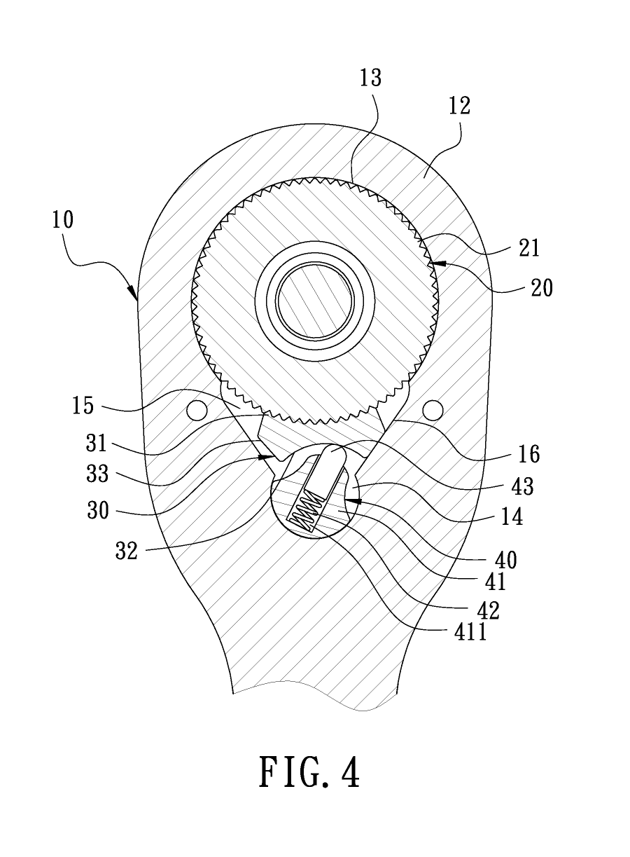

Referring to FIGS. 2 to 4 which show perspective view, exploded perspective view and sectional view of an embodiment of a high torque ratchet wrench in accordance with the present invention, the torque wrench comprises a wrench body 10 having a head portion 12 with an upper surface 121 and a lower surface 122, and an extended handle 11 for a user to hold and operate the same. The head portion 12 is formed with a chamber 13 therein between the upper surface 121 and the lower surface 122. The chamber 13 is substantially in a flat cylindrical shape so that a driving gear 20 can be fitted therein. The head portion 12 also comprises a slot 14 formed near the extended handle 11 and being substantially in a cylindrical shape for the installation of a controller 40. The central axis of the slot 14 is parallel to the same of the chamber 13. A recess 15 is formed between the slot 14 and the chamber 13 for the installation of a ratchet block 30. In the chamber 13 of the head portion 12, there is formed a holding surface section 16 which is substantially a flat surface.

A driving gear 20 is installed in the chamber 13 of the head portion 12 of the wrench body 10. The driving gear 20 comprises a plurality of gear teeth 21 and an adaptor 22 extended from the center portion thereof to be fitted into a socket for driving a work piece such as a screw or the like.

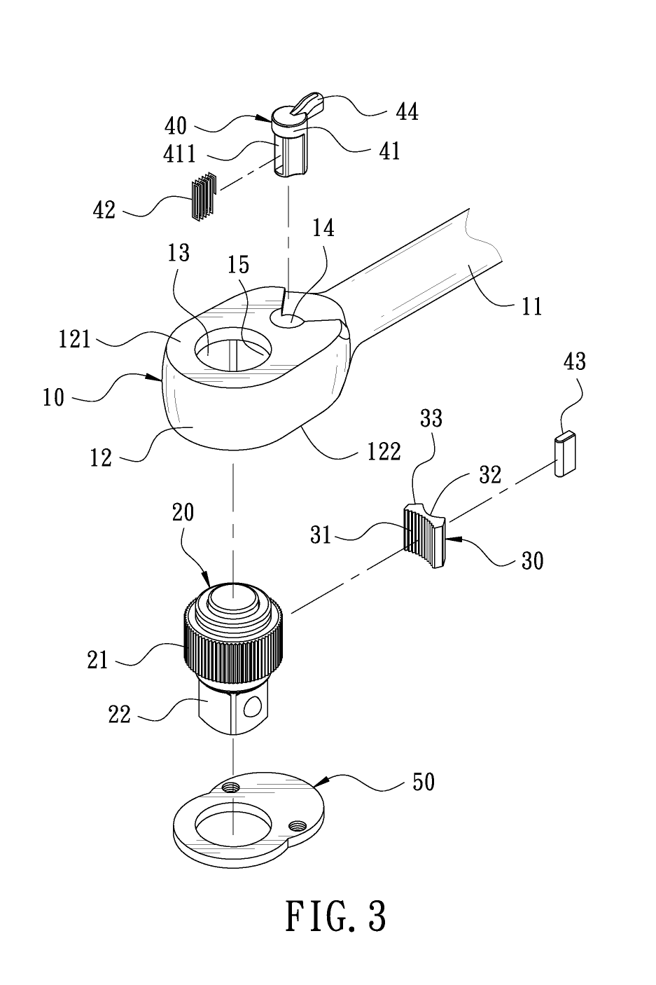

Referring particularly to FIG. 3, the controller 40 comprises a body 41 having a vertical recess 411 formed therein for the installation of an elastic member 42 and a pressing pin 43. Extended from the body 41 of the controller 40, there is formed a lever 44 for user to actuate the same to adjust the wrench operation direction in either clockwise or counter clockwise.

A ratchet block 30 is installed in the recess 15 in the head portion 12 of the wrench body 10. The ratchet block 30 comprises a plurality of ratchet teeth 31 facing the gear teeth 21 of the driving gear 20 and matched there between. The ratchet block 30 is formed with a curved section 32 which is being driven by the pressing pin 43 of the controller 40. The ratchet block 30 also formed at both sides a pressing surface section 33 which shall be in contact with the holding surface section 16 in the chamber 13.

The assembly of the high torque wrench in accordance with the present invention can be readily understood by referring to the exploded structure of the wrench shown in FIG. 3. The elastic member 42 is inserted in the recess 411 and pushed by the pressing pin 43. Then the assembled controller 40 shall be pushed into the slot 14. The ratchet block 30 and the driving gear 20 will be installed in the chamber 13. A base cover plate 50 will be used to cover the chamber 13 with a pair of screws which are not show in the drawing.

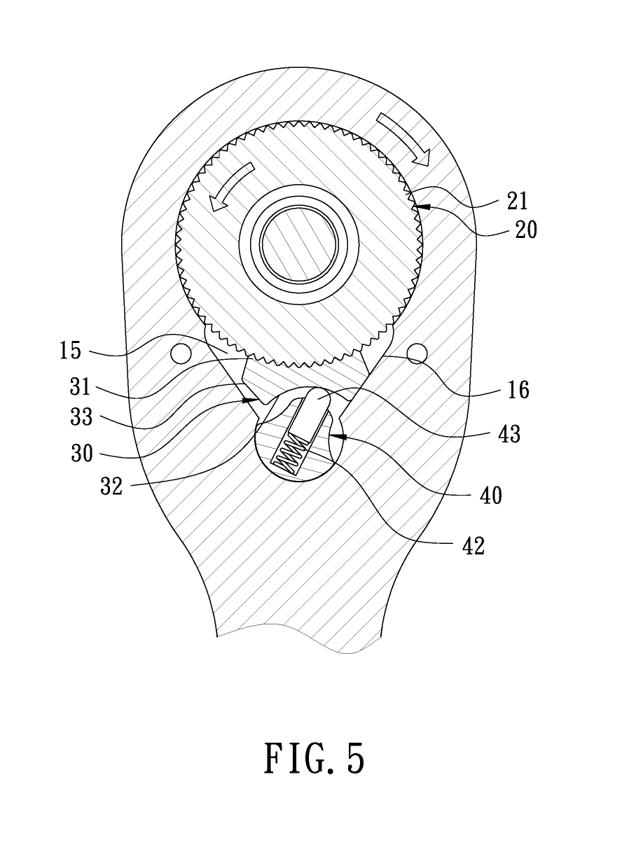

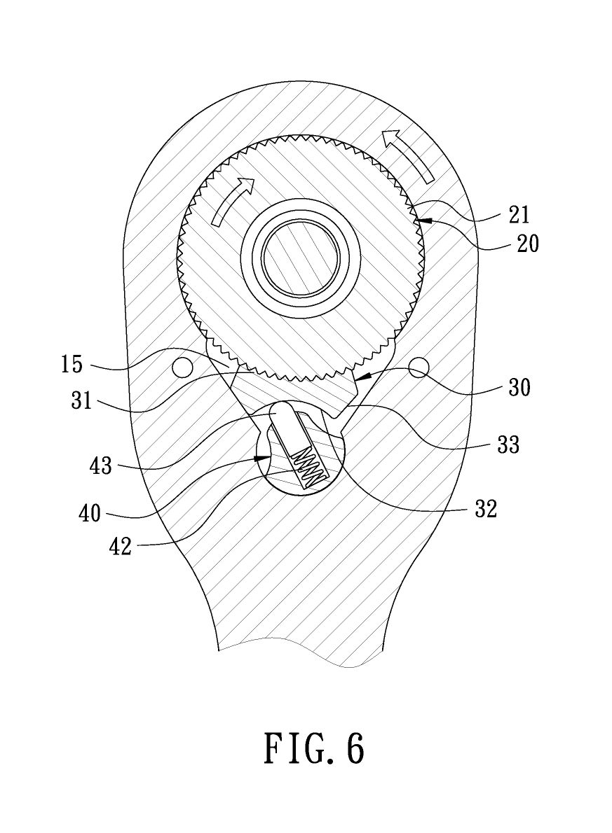

The operation of the high torque wrench in accordance to the present invention can be understood by referring to FIGS. 5 and 6 which are sectional views of an embodiment of a high torque ratchet wrench in accordance to the present invention illustrating the operation of the wrench being turned clockwise and counter clockwise. In FIG. 5, the pressing pin 43 is pushed by the elastic member 42 to touch the right half of the curvature section 32 of the ratchet block 30. In the meantime, the pressing surface section 33 of the ratchet block 30 is against and closely in contact with the holding surface section 16 in the chamber 13. The ratchet teeth 31 on the ratchet block 30 are formed with a curvature radius which is substantially equal to the same of the driving gear 20. Therefore, it is a perfect match between the ratchet teeth 31 of the ratchet block 30 and the gear teeth 21 of the driving gear 20. The ratchet wrench can be operated to turn clockwise.

Referring to FIG. 6, user adjusted the lever 44 of the controller 40 to a second position. The pressing pin 43 is pushed by the elastic member 42 to touch the left half of the curvature section 32 of the ratchet block 30. The pressing surface section 33 of the ratchet block 30 is against and closely in contact with the other holding surface section 16 in the chamber 13.

Since the pressing surface section 33 of the ratchet block 30 is against and closely in contact with the holding surface section 16 in the chamber 13 and there is a perfect match between the ratchet teeth 31 of the ratchet block 30 and the gear teeth 21 of the driving gear 20, the wrench of the present invention can achieve a high torque operation without damaging the gear teeth of the same.

Although the high torque ratchet wrench of the present invention has been described in way of preferred embodiment, it is apparent and readily understood that various changes, improvement and modifications can still be made without departing from the spirit of the invention and shall be fallen in the protection scope as the Claims in the present invention.

What is claimed is:

1. A high torque ratchet wrench comprising:
a head portion having a chamber for the installation of a driving gear which comprises a plurality of gear teeth;
a slot formed in said head portion for the installation of a controller which further comprising a control body having a recess formed therein for storing an elastic member, and a pressing pin biased by said elastic member; and
a ratchet block having a plurality of ratchet teeth formed thereon, a curvature section being contacted by said pressing pin of said controller, and a pair of pressing surface sections formed thereon;
characterized in said chamber in said head portion comprising a pair of holding surface sections corresponding to said pressing surface sections of said ratchet block and substantially closely in touch with each other;
said driving gear having a radius substantially equal to the same of said ratchet teeth of said ratchet block thereby said ratchet teeth of said ratchet block will be substantially matched with said gear teeth of said driving gear.

2. A high torque ratchet wrench in accordance with claim 1 wherein said pressing pin of said controller being pushed by said elastic member against one end of said curvature section of said ratchet block to control the direction of rotation of the torque ratchet wrench.
